(19) United States
(12) Patent Application Publication
(10) Pub. No.: US 2026/0169793 A1
(43) Pub. Date: Jun. 18, 2026

(54) NATURAL LANGUAGE API

(71) Applicant: ServiceNow, Inc., Santa Clara, CA (US)

(72) Inventors: Vadim Dukhovny, Petah Tikva (IL); Brian Javier Dyk, Kfar Saba (IL); Ofir Kapustian, Ramat-Gan (IL); Barel Mengel, Petah Tikva (IL); Dov Harel, Nir Galim (IL); Robert Bitterfeld, Petah Tikva (IL)

(21) Appl. No.: 18/983,757

(22) Filed: Dec. 17, 2024

(51) Int. Cl. G06F 9/48; G06F 16/242; G06F 16/248; G06N 3/042

(52) U.S. Cl. CPC G06F 9/4881; G06F 16/243; G06F 16/248; G06N 3/042

(57) ABSTRACT

A method includes obtaining a query and determining a task to be performed based on the query by a task dispatcher LLM. The method includes routing, by the task dispatcher LLM, a prompt to one of a plurality of LLM-based agents based on the task to be performed. The method includes obtaining information uniquely associated with the one of the plurality of LLM-based agents and conditioning the one of the plurality of LLM-based agents on the obtained information. The method includes generating a response to the prompt by the one of the plurality of LLM-based agents conditioned on the obtained information. The method includes generating an output based on the response to the prompt by the task dispatcher LLM.

### TECHNICAL FIELD

This disclosure relates to an application programming interface.

### BACKGROUND

Application Programming Interfaces (APIs) serve as intermediaries that enable different software applications to communicate with each other, thereby facilitating the integration of diverse systems. APIs provide the necessary tools for developers to create complex applications that interact with other software components. Current APIs rely on structured data formats and specific protocols to enable such communication, often requiring developers to possess specialized knowledge and skills to effectively utilize current APIs. The specialized knowledge serves as a barrier to entry for some users. As such, as the complexity and volume of data handled by software applications have increased, there has been a growing demand for more intuitive and accessible methods of interaction.

### SUMMARY

One implementation of the disclosure provides a computer-implemented method of processing queries using a virtual agent with a plurality of LLM-based agents. The method includes obtaining a query and determining, by a task dispatcher LLM, a task to be performed based on the query. The method includes routing, by the task dispatcher LLM, a prompt to one of a plurality of LLM-based agents based on the task to be performed and obtaining, by the one of the plurality of LLM-based agents, information uniquely associated with the one of the plurality of LLM-based agents. The method includes conditioning the one of the plurality of LLM-based agents on the obtained information and generating a response to the prompt by the one of the plurality of LLM-based agents conditioned on the obtained information. The method includes generating, by the task dispatcher LLM, an output based on the response.

Implementations of the disclosure may include one or more of the following optional features. In some implementations, the task dispatcher LLM determines the task to be performed using chain of thought (CoT) reasoning. The task to be performed may be one of a sequence of tasks to be performed for the query. In some examples, the one of the plurality of LLM-based agents obtains the information uniquely associated with the one of the plurality of LLM-based agents using retrieval augmented generation (RAG).

The information uniquely associated with the one of the plurality of LLM-based agents may include one or more tools associated with the one of the plurality of LLM-based agents. In some implementations, the information uniquely associated with the one of the plurality of LLM-based agents includes one or more capabilities associated with the one of the plurality of LLM-based agents. The information uniquely associated with the one of the plurality of LLM-based agents may include one or more actions associated with the one of the plurality of LLM-based agents. In some examples, the information uniquely associated with the one of the plurality of LLM-based agents includes a knowledge base associated with the one of the plurality of LLM-based agents. The method may further include determining that the output resolves the query by the task dispatcher and providing the output as a final answer to the query.

In some implementations, the method further includes determining that the output does not resolve the query by the task dispatcher, determining a second task to be performed based on the query and the output, and routing, by the task dispatcher LLM, a second prompt to a second one of the plurality of LLM-based agents based on the second task to be performed. In these implementations, the method may further include obtaining second information uniquely associated with the second one of the plurality of LLM-based agents by the second one of the plurality of LLM-based agents, conditioning the second one of the plurality of LLM-based agents on the obtained second information, generating a second response to the second prompt by the second one of the plurality of LLM-based agents conditioned on the obtained second information, and generating a second output based on the second response to the second prompt by the task dispatcher LLM. Here, the method may further include determining, by the task dispatcher, that the second output resolves the query and providing the second output as a final answer to the query.

In some examples, each LLM-based agent of the plurality of LLM-based agents is conditioned to perform a respective type of task. In these examples, the task dispatcher may be prompted on the respective type of task that each LLM-based agent of the plurality of LLM-based agents is conditioned to perform. The prompt may include a natural language description of the task to be performed. In some implementations, the method further includes generating, by a virtual agent, a natural language response based on the output. In these implementations, the method may further include displaying the natural language response on a graphical user interface of a user device. Conditioning the one of the plurality of LLM-based agents on the obtained information may include at least one of prompting the one of the plurality of LLM-based agents using the obtained information, training the one of the plurality of LLM-based agents on the obtained information, or fine-tuning the one of the plurality of LLM-based agents on the obtained information.

Another implementation of the disclosure provides a system that includes data processing hardware and memory hardware storing instructions that when executed on the data processing hardware causes the data processing hardware to perform operations. The operations include obtaining a query and determining, by a task dispatcher LLM, a task to be performed based on the query. The operations include routing, by the task dispatcher LLM, a prompt to one of a plurality of LLM-based agents based on the task to be performed and obtaining, by the one of the plurality of LLM-based agents, information uniquely associated with the one of the plurality of LLM-based agents. The operations include conditioning the one of the plurality of LLM-based agents on the obtained information and generating a response to the prompt by the one of the plurality of LLM-based agents conditioned on the obtained information. The operations include generating, by the task dispatcher LLM, an output based on the response.

Another implementation of the disclosure provides a computer-readable medium having instructions that, when executed by data processing hardware, causes the data processing hardware to perform operations. The operations include obtaining a query and determining, by a task dispatcher LLM, a task to be performed based on the query.

The operations include routing, by the task dispatcher LLM, a prompt to one of a plurality of LLM-based agents based on the task to be performed and obtaining, by the one of the plurality of LLM-based agents, information uniquely associated with the one of the plurality of LLM-based agents. The operations include conditioning the one of the plurality of LLM-based agents on the obtained information and generating a response to the prompt by the one of the plurality of LLM-based agents conditioned on the obtained information. The operations include generating, by the task dispatcher LLM, an output based on the response.

The details of one or more implementations of the disclosure are set forth in the accompanying drawings and the description below. Other implementations, features, and advantages will be apparent from the description and drawings, and from the claims.

### DESCRIPTION OF DRAWINGS

FIGS. 1A and 1B are schematic views of an example system executing a virtual agent with a plurality of LLM-based agents.

FIG. 2 is a schematic view of an example conditioned task dispatcher LLM.

FIG. 3 is a schematic view of an example plurality of conditioned LLM-based agents.

FIG. 4 illustrates an example graphical user interface displayed on a user device of a sequence of natural language responses generated by the virtual agent.

FIG. 5 is a flowchart of an example arrangement of operations for a computer-implemented method of generating software code using a multi-agent code generator.

FIG. 6 is a schematic view of an example computing device that may be used to implement the systems and methods described herein.

Like reference symbols in the various drawings indicate like elements.

### DETAILED DESCRIPTION

Current approaches for integrating and collaborating between various software products are predominantly facilitated through hard-coded Application Programming Interfaces (APIs). APIs are defined with specific capabilities, which requires developers to anticipate and predict the required APIS in advance. The necessity to foresee and predefine APIs limits flexibility and adaptability of the APIs, often leading to inefficiencies and the need for frequent updates as requirements evolve. Moreover, the rigid nature of these predefined APIs may impede the communication and interoperability between different software systems. As the complexity and diversity of software applications continue to grow, the demand for more dynamic and flexible methods of integration becomes increasingly apparent. Current APIs, with their static definitions, struggle to accommodate the evolving nature of modern software environments.

Implementations herein are directed towards a natural language API. The natural language API obtains a query and determines a task to be performed based on the query using a task dispatcher LLM. The task dispatcher LLM routes a prompt to one of a plurality of LLM-based agents based on the task to be performed. The one of the plurality of LLM-based agents obtains information uniquely associated with the one of the plurality of LLM-based agents and the natural language API conditions the one of the plurality of LLM-based agents on the obtained information. The one of the plurality of LLM-based agents conditioned on the obtained information generates a response to the prompt and the natural language API generates an output based on the response to the prompt.

Advantageously, the natural language API flexibly handles various types of tasks. The natural language API is also modular such that LLM-based agents may seamlessly be added to, or removed from, the plurality of LLM-based agents. The modular architecture ensures that the integration or removal of these agents does not disrupt the overall functionality of the API. The modular architecture is particularly beneficial in dynamic environments where the requirements may change over time, necessitating the addition of new agents or the removal of existing ones. Moreover, each LLM-based agent is specifically tailored to perform a certain type of task which allows each agent to operate with a high degree of efficiency and accuracy for the certain type of task. For instance, one LLM-based agent might be optimized for alert analysis, while another may be designed for language translation. By leveraging the strengths of multiple specialized LLM-based agents, the natural language API is capable of providing comprehensive and nuanced responses to a wide range of queries. Moreover, current APIs require that users possess a comprehensive understanding of the architecture of the APIs to effectively execute API calls. In contrast, the natural language API allows users to submit queries in natural language. Natural language queries enable users to interact with the natural language API without requiring prior knowledge or expertise in making structured API calls.

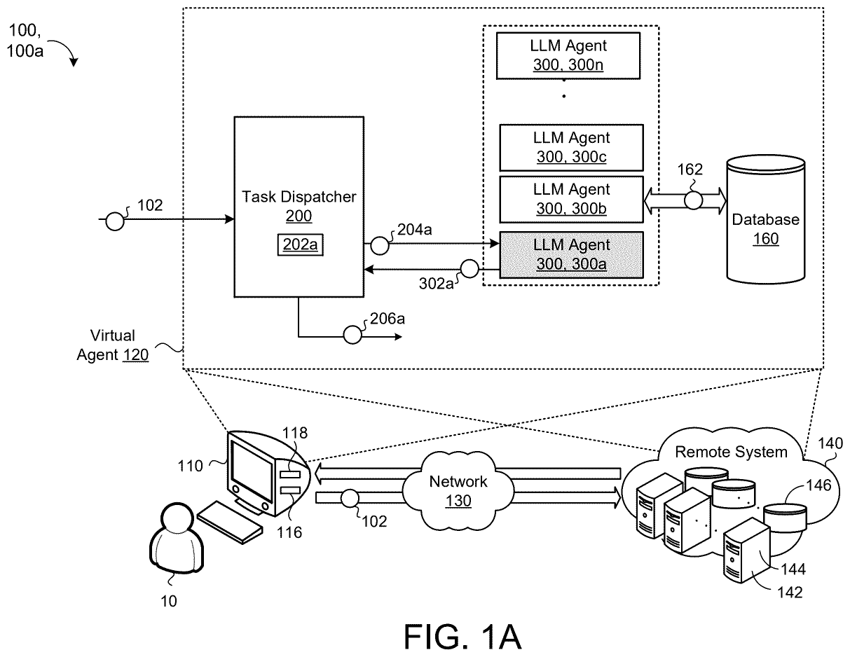

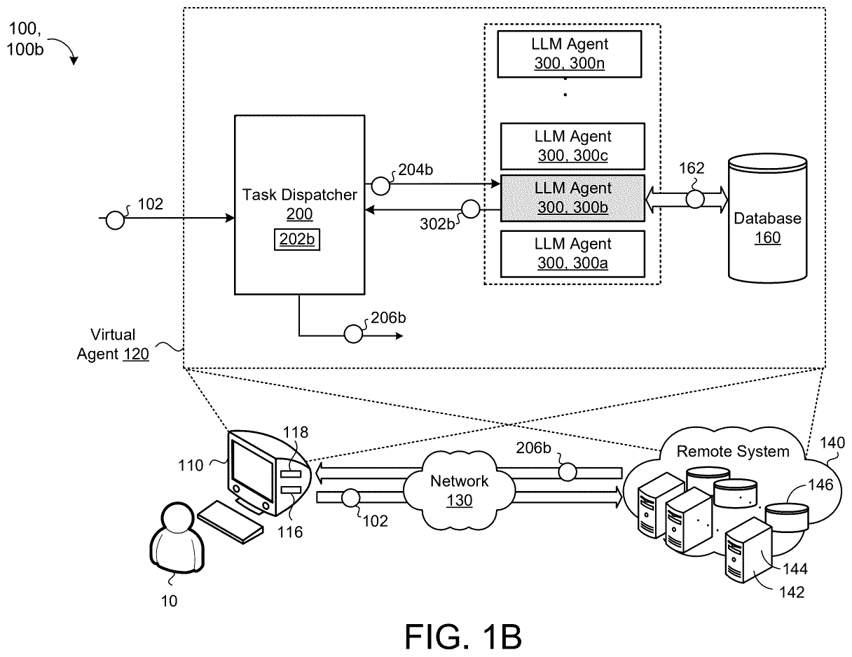

Referring to FIGS. 1A and 1B, in some implementations, a system 100 includes a remote system 140 in communication with one or more user device 110 each associated with a respective user 10 via a network 130, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 130. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware).

The remote system 140 and/or the user device 110 may execute a virtual agent 120. The virtual agent 120 includes a task dispatcher LLM 200 and a plurality of LLM-based agents 300, 300a-n. The task dispatcher 200 manages and coordinates the plurality of LLM-based agents 300 to process queries 102. The queries 102 may be natural language inputs from the user 10 including, but not limited to, a voice command (e.g., spoken input) or a textual input. The natural language input of the query 102 may be a request, a question, or a problem related to the service or product provided by the remote system 140 and/or the user device 110. In some implementations, the query 102 may be a request to perform an information technology (IT) operations management (ITOM) task. An ITOM task may involve managing, maintaining, or improving the performance, availability, or security of the IT infrastructure, applications, or services that support the business processes and objectives of the user 10 or the remote system 140. ITOM tasks may include, but are not limited to, monitoring the health and status of the IT resources, troubleshooting and resolving IT issues, optimizing the IT resource utilization and efficiency, automating the IT workflows and processes, and enforcing the IT policies and compliance. For example, the query 102 may be “our clients cannot make payments on our website,” “how can I increase the disk space on the server,” or “what is the root cause of the network outage.”

The task dispatcher LLM 200 receives the query 102 and processes the content of the query 102 to determine a task 202 to be performed. As will become apparent, the task 202 to be performed may be one of a sequence of tasks 202 to be performed for the query 102. That is, if a response for a task 202 does not address the query 102 entirely, the virtual agent 120 may determine another task 202 to be performed until the query 102 entirely or sufficiently resolved. The task dispatcher LLM 200 may process the query 102 using natural language processing techniques to identify an intent and context of the query 102. For example, the task dispatcher LLM 200 may use natural language understanding, semantic analysis, sentiment analysis, or dialogue management techniques to extract the meaning, the purpose, the tone, or the state of the query 102. In some examples, the task dispatcher LLM 200 determines the task 202 to be performed using chain of thought (CoT) reasoning. CoT reasoning is a technique that allows the task dispatcher LLM 200 to infer the logical steps and subtasks that are required to achieve the intent of the query 102, based on the available information and the domain knowledge. For example, the task dispatcher LLM 200 may use CoT reasoning to determine that the task 202 for the query 102 “our clients cannot make payments on our website” is to troubleshoot the payment system and provide a solution or an alternative to the user 10. The task dispatcher LLM 200 may also use CoT reasoning to determine the appropriate LLM-based agent 300, 300a-n to assign the task 202 to, based on the capabilities, availability, and reliability of the LLM-based agents 300.

Based on the task 202 determined for the query 102, the task dispatcher LLM 200 determines a prompt 204 that is tailored for the task 202. The prompt 204 may be a specific instruction or question that is configured to elicit the necessary information from the LLM-based agents 300. Put another way, the prompt 204 may be a natural language description of the task 202 to be performed. For example, if the task 202 is to troubleshoot a payment issue on the website, the task dispatcher LLM 200 may determine the prompt 204 that asks the LLM-based agent 300 to verify the payment method, the billing address, the security code, and the error message displayed on the website. The task dispatcher LLM 200 routes the prompt 204 to one of the plurality of LLM-based agents 300 based on the task 202 to be performed. That is, each of the LLM-based agents 300 may be specialized to perform particular types of tasks 202. As such, the task dispatcher LLM 200 routes the prompt 204 to the LLM-based agent 300 best suited to perform the task 202. For instance, the task dispatcher LLM 200 may route the prompt 204 to an LLM-based agent 300 that has access to the website database, the payment gateway, and the customer service system. Alternatively, the task dispatcher LLM 200 may route the prompt 204 to an LLM-based agent 300 that has been trained to handle payment-related queries using natural language processing and machine learning techniques. The task dispatcher LLM 200 may also consider other factors, such as the urgency, the priority, the complexity, or the cost of the task 202, when routing the prompt 204 to the LLM-based agent 300.

In some examples, the virtual agent 120 obtains information 162 from a database 160 whereby the information 162 is uniquely associated with the task dispatcher LLM 200. Thereafter, the task dispatcher LLM 200 may condition the task dispatcher LLM 200 on the obtained information 162 to guide the task dispatcher LLM 200 to determine the task 202 for queries 102, generate prompts 204 for the tasks 202, and route the prompts 204 to the LLM-based agent 300 best suited to handle the task 202. The virtual agent 120 may condition the task dispatcher LLM 200 on the obtained information 162 before receiving or processing the query 102, or dynamically during processing of the query 102.

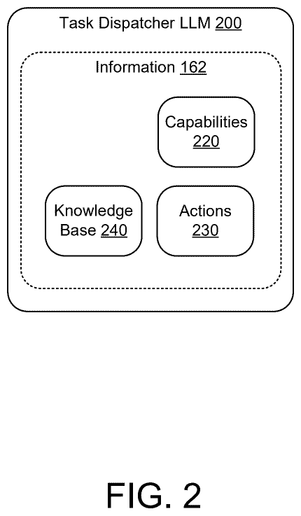

Referring now to FIG. 2, in some implementations, the task dispatcher LLM 200 is conditioned on respective information 162 uniquely associated with the task dispatcher LLM 200. Conditioning the task dispatcher LLM 200 on the respective information 162 tailors the task dispatcher LLM 200 to determine the task 202 to be performed from the query 102, generate the prompt 204 to cause the task 202 to be performed, and route the prompt 204 to the most suitable LLM-based agent 300 of the plurality of LLM-based agents 300. The respective information 162 used to condition the task dispatcher LLM 200 may include one or more capabilities 220 associated with the task dispatcher LLM 200, one or more actions 230 associated with the task dispatcher LLM 200, and a knowledge base 240 associated with the task dispatcher LLM 200. The capabilities 220 may include routing the prompt 204 to one of the LLM-based agents 300. The actions 230 may include dispatching the task 202 to be performed by one of the LLM-based agents 300. The knowledge base 240 may include a list of the plurality of LLM-based agents 300 and the respective types of tasks 202 each LLM-based agent 300 is conditioned to perform.

As such, the virtual agent 120 may use the information 162 uniquely associated with the task dispatcher LLM 200, or some portion thereof, to condition the task dispatcher LLM 200. The virtual agent 120 may condition the task dispatcher LLM 200 by creating a conditioning prompt based on the information 162 and causing the task dispatcher LLM 200 to process the conditioning prompt before processing the query 102. The conditioned task dispatcher LLM 200 is guided by the conditioning prompt to determine the task 202 of the queries, generate prompts 204 for the tasks 202, and route the prompts 204. For instance, the conditioning prompt may include the respective type of task 202 that each LLM-based agent 300 of the plurality of LLM-based agents 300 is conditioned to perform.

Referring back to FIGS. 1A and 1B, after determining the prompt 204, the task dispatcher LLM 200 routes the prompt 204 to one of the plurality of LLM-based agents 300 based on the task 202 to be performed for the query 102. The prompt 204 may include the query 102 or a modified version of the query 102. For example, the prompt 204 may include additional information, such as context, preferences, or constraints, that may help the LLM-based agent 300 to generate a more accurate and relevant response 302. The task dispatcher LLM 200 is conditioned to know which tasks 122 each of the plurality of LLM-based agents 300 is configured to perform. Accordingly, the task dispatcher LLM 200 may select the most relevant LLM-based agent 300 for performing the task 122 and route the prompt 204 to the selected LLM-based agent 300.

In some examples, based on receiving the prompt 204, the one of the plurality of LLM-based agents 300 obtains information 162 uniquely associated with the one of the plurality of LLM-based agents 300 such that the virtual agent 120 conditions the one of the plurality of LLM-based agents 300 on the obtained information 162. The information 162 may be stored in the database 160 such that the LLM-based agent 300 obtains the information 162 from the database 160. In other examples, the one of the plurality of LLM-based agents 300 obtains the information 162 uniquely associated with the one of the plurality of LLM-based agents 300 before receiving the prompt 204 such that the virtual agent 120 conditions the one of the plurality of LLM-based agents 300 before processing the prompt 204. The virtual agent 120 may condition the LLM-based agent 300 before receiving or processing the query 102. In these examples, each respective LLM-based agent 300 of the plurality of LLM-based agents 300 obtains respective information 162 uniquely associated with the respective LLM-based agent 300 such that the virtual agent 120 conditions the respective LLM-based agent 104 before processing the prompt 204.

The virtual agent 120 may condition the LLM-based agent 300 by creating a conditioning prompt based on the information 162 uniquely associated with the LLM-based agent 300 that causes the LLM-based agent to process the conditioning prompt before processing the prompt 204. The conditioned task dispatcher LLM 200 is guided by the conditioning prompt to determine a response 302 by processing the prompt 204 for a respective type of task 202. Each LLM-based agent 300 is conditioned on different information 162 such that each LLM-based agent 300 is conditioned to perform different types of tasks 202. The virtual agent 120 may condition the LLM-based agent 300 by training or fine-tuning the LLM-based agent 300 on the obtained information 162 in addition to, or in lieu of, using the conditioning prompt. The one of the plurality of LLM-based agents obtains the information 162 uniquely associated with the one of the plurality of LLM-based agents 300 using retrieval augmented generation (RAG). RAG is a technique that enables the LLM-based agent 300 to retrieve relevant information 162 from a large-scale knowledge source, such as the database 160, a corpus, a web page, or any other suitable source of information, and incorporate it into the generation of a response 302.

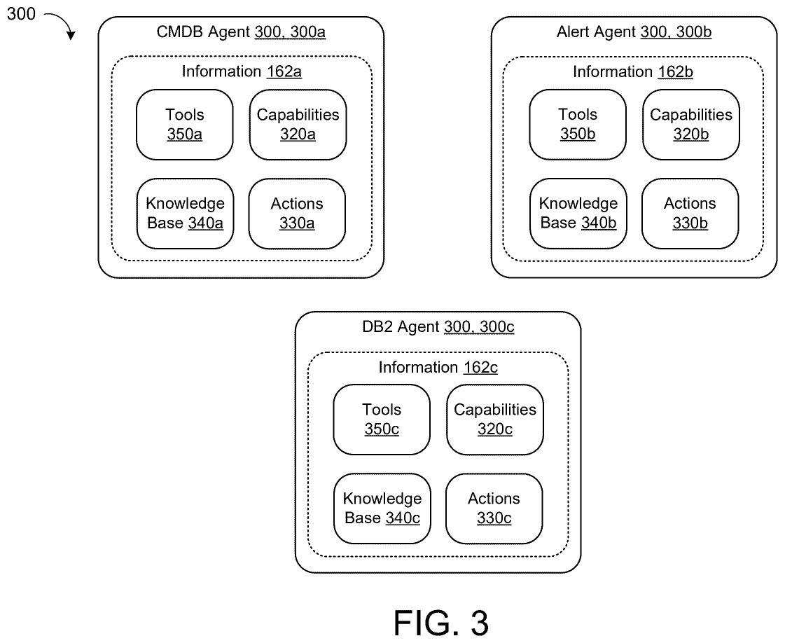

Referring now to FIG. 3, in some implementations, each respective LLM-based agent 300 of the plurality of LLM-based agents 300 is conditioned to perform a respective type of task 202. As such, each respective LLM-based agent 300 may be conditioned on respective information 162 uniquely associated with the respective LLM-based agent 300. The respective information 162 used to condition each LLM-based agent 300 tailors the LLM-based agent 300 to perform the respective type of task 202. In the example shown, the plurality of LLM-based agents 300 includes three LLM-based agents 300, 300a-c, each of which is conditioned on respective information 162, 162a-c. The first LLM-based agent 300a is conditioned to perform configuration management database (CMDB) related tasks 202, such as identifying and updating the configuration items and their relationships in the CMDB. The second LLM-based agent 300b is conditioned to perform alert analysis related tasks 202, such as detecting, correlating, and prioritizing alters from various sources and systems. The third LLM-based agent 300c is conditioned to perform DB2 related tasks 202, such as querying, monitoring, and optimizing the performance of DB2 databases.

The information 162 uniquely associated with each of the plurality of LLM-based agents 300 may include at least one of one or more capabilities 320 associated with the one of the plurality of LLM-based agents 300, one or more actions 330 associated with the one of the plurality of LLM-based agents 300, a knowledge base 340 associated with the one of the plurality of LLM-based agents 300, and/or one or more tools 350 associated with the one of the plurality of LLM-based agents 300. The capabilities 320 may define the ability of the LLM-based agent to perform the type of task 202. The actions 330 may specify the steps that the LLM-based agent 300 may execute to perform the type of task 202. The knowledge base 340 may store the data that the LLM-based agent 300 may access and apply to perform the type of task 202. The tools 350 may provide the functions and the interfaces that the LLM-based agent 300 may use to perform the type of task 202.

Continuing with the example shown, the first LLM-based agent 300a is conditioned on first information 162a that includes one or more respective capabilities 320a associated with the first LLM-based agent 300a, one or more respective actions 330a associated with the first LLM-based agent 300a, a respective knowledge base 340a associated with the first LLM-based agent 300a, and/or one or more respective tools 350a associated with the first LLM-based agent 300a. The respective capabilities 320a of the first LLM-based agent 300a may include, for example, matching text to applications and services. That is, the respective capabilities 320a may match text from the prompts 204 to related applications or services. The respective actions 330a of the first LLM-based agent 300a may include retrieving the relevant applications or services from the CMDB based on the prompt 204, comparing the retrieved applications or services with the prompt 204, and modifying the CMDB accordingly. Moreover, the respective knowledge base 340a of the first LLM-based agent 300a may include a table of service mappings that associates text patterns with the applications and services. The respective tools 350a of the first LLM-based agent 300a may include retrieving potential applications that match the text and retrieving potential services that match the text.

The second LLM-based agent 300b in the example shown is conditioned on second information 162b that includes one or more respective capabilities 320b associated with the second LLM-based agent 300b, one or more respective actions 330b associated with the second LLM-based agent 300b, a respective knowledge base 340b associated with the second LLM-based agent 300b, and/or one or more respective tools 350b associated with the second LLM-based agent 300b. The respective capabilities 320b of the second LLM-based agent 300b may include, for example, identifying entities, terms, and any ambiguous text from the prompts 204 and matching the identifications against a classification database. The respective actions 330b of the second LLM-based agent 300b may include receiving alerts from various sources, creating a binding for an event, and communicating with the first LLM-based agent 300a or the third LLM-based agent 300c. Moreover, the respective knowledge base 340b of the second LLM-based agent 300b may include a database of alerts and a database of categories, each of which may include predefined or dynamically generated entries based on the alert analysis. The respective tools 350b of the second LLM-based agent 300b may include retrieving data from the alert database.

Continuing with the example shown, the third LLM-based agent 300c is conditioned on third information 162c that includes one or more respective capabilities 320c associated with the third LLM-based agent 300c, one or more respective actions 330c associated with the third LLM-based agent 300c, a respective knowledge base 340c associated with the third LLM-based agent 300c, and/or one or more respective tools 350c associated with the third LLM-based agent 300c. The respective capabilities 320c of the third LLM-based agent 300c may include, for example, fixing the problem associated with the query 102. The respective actions 330c of the third LLM-based agent 300c may include fixing a database associated with the problem. Moreover, the respective knowledge base 340c of the third LLM-based agent 300c may include a knowledge article. The respective tools 350c of the third LLM-based agent 300c may include retrieving the relevant fix from the knowledge article.

As such, in the example shown, the LLM-based agent 300a is conditioned to perform CMDB related tasks 202 based on the virtual agent 120 conditioning the LLM-based agent 300a on the information 162a. The CMDB related tasks 202 may include, for example, updating, querying, or validating the configuration items and their relationships in the CMDB. Moreover, the second LLM-based agent 300b is conditioned to perform alert analysis related tasks 202 based on the virtual agent 120 conditioning the LLM-based agent 300b on the information 162b. The alert analysis related tasks 202 may include, for example, detecting, correlating, or resolving the alerts generated by the monitoring systems. Similarly, the third LLM-based agent 300c is conditioned to perform DB2 related tasks 202 based on the virtual agent 120 conditioning the LLM-based agent 300c on the information 162c. The DB2 related tasks 202 may include, for example, performing backup, recovery, or tuning operations on the DB2 database 160. In some implementations, the LLM-based agents 300a-c communicate with each other or with the task dispatcher LLM 200 to coordinate or optimize the tasks 202.

Referring back to FIGS. 1A and 1B, the one of the plurality of LLM-based agents 300 that the task dispatcher LLM 200 routed the prompt 204 to and is conditioned on the obtained information 162, generates a response 302 to the prompt 204. The response 302 may include answering a question, identifying an issue with the application or service, or performing an action. For example, the conditioned LLM-based agent 300 may process the prompt 204 to identify a source of an issue with an application or service whereby the response 302 indicates the source of the issue. In another example, the conditioned LLM-based agent 300 may process the prompt 204 to locate the root cause of the issue with the application or service and perform an action to resolve the issue. Here, the response 302 may indicate that the LLM-based agent 300 performed an action to resolve the issue. Moreover, the response 302 may provide information about the status, features, or functionality of the application or service, suggest a solution or a workaround for a problem, request additional information or clarification from the user 10, or execute a command or a function of the application or service.

The task dispatcher LLM 200 receives the response 302 from the LLM-based agent 300 and generates an output 206 based on the response 302. In some examples, the response 302 from the LLM-based agent 300 serves as the output 206. For instance, the task dispatcher LLM 200 may determine that the response 302 resolves the query 102. That is, the task dispatcher LLM 200 determines, based on the response 302, that the query 102 has been fully addressed such that no further actions need to be taken by the virtual agent 120. Here, the task dispatcher LLM 200 provides the output 206 as a final answer to the query 102. In other examples, the task dispatcher LLM 200 determines that the response 302 does not resolve the query 102. That is, the task dispatcher LLM 200 may determine that one or more additional actions need to be taken to address the query 102 based on the response 302.

Referring now specifically to FIG. 1A, in some implementations, a first system 100, 100a uses the task dispatcher LLM 200 to determine a first task 202 to be performed based on the query 102 and routes a first prompt 204a to the first LLM-based agent 300a of the plurality of LLM-based agents 300. The first LLM-based agent 300a is conditioned on information 162 uniquely associated with the first LLM-based agent 300a and generates a first response 302, 302a by processing the first prompt 204a. The task dispatcher LLM 200 may generate a first output 206, 206a based on the first response 302a. The task dispatcher LLM 200 may determine that the output 206a does not resolve the query 102 and that additional tasks 122 need to be performed to resolve the query 102.

Referring now specifically to FIG. 1B, in some implementations, a second system 100, 100b uses the task dispatcher LLM 200 to determine a second task 202b to be performed based on the query 102 and the first response 302a. Moreover, the task dispatcher LLM 200 may determine a second prompt 204 based on the second task 202b to be performed and route the second prompt 204g to the second LLM-based agent 300b. The second LLM-based agent 300b is conditioned on information 162 uniquely associated with the second LLM-based agent 300b and generates a second response 302, 302b by processing the second prompt 204b. The task dispatcher LLM 200 may generate a second output 206, 206b based on the second response 302b and, in some examples, the first response 302a. Here, the task dispatcher LLM 200 determines that the second output 206b resolves the query 102 such that the virtual agent 120 provides the second output 206b as a final answer to the query 102.

Accordingly, as shown in FIGS. 1A and 1B, the virtual agent 120 uses multiple LLM-based agents 300 to process the query 102 and provide an output 206 that addresses or resolves the query 102. The virtual agent 120 may use a single LLM-based agent 300 that generates a single output 206 to resolve the query 102. On the other hand, the virtual agent 120 may use multiple LLM-based agents 300 that each generate a respective output 206 whereby the virtual agent 120 uses each output 206 to resolve the query 102. Moreover, since the virtual agent 120 uses the task dispatcher LLM 200 to route each prompt 204 to the most suitable LLM-based agent 300, the virtual agent 120 ensures that high quality responses 302 are generated for each prompt 204 as each LLM-based agent 300 is conditioned to perform a respective type of task 202.

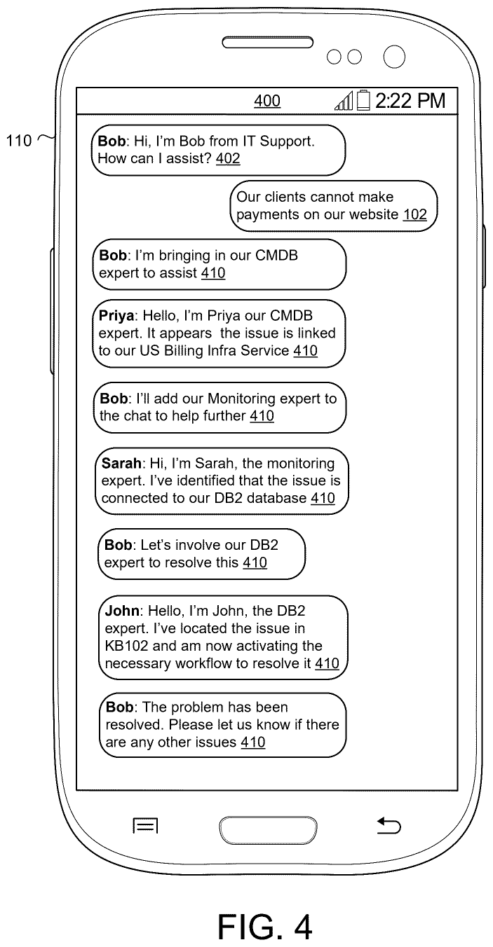

Referring now to FIG. 4, in some implementations, the user device 110 displays a graphical user interface 400 of the virtual agent 120. That is, the virtual agent 120 may correspond to an application programming interface (API) such that users 10 may communicate with the API using natural language (e.g., natural language textual inputs or natural language speech). In some examples, the virtual agent 120 generates a natural language response 410 based on the output 206 and/or each response 302 received from the plurality of LLM-based agents 300. The natural language responses 410 may be displayed on the graphical user interface 400 of the user device 110.

In the example shown, the graphical user interface 400 of the user device 110 displays a first message 402 to which the user 10 responds with the query 102 of “our clients cannot make payments on our website.” The first message 402 is generated by the task dispatcher LLM 200 but is associated with the alias “Bob” to humanize the user experience. The task dispatcher LLM 200 may process the query 102 to determine a task 202 to investigate the issue described in the query 102, generate a prompt 204, and route the prompt 204 to an LLM-based agent 300 specialized in CMDB. The virtual agent 120 may generate a natural language response 410 explaining that the prompt 204 is being routed to the LLM-based agent 300 specialized in CMDB with the alias of “Priya.” The LLM-based agent 300 processes the prompt 204 and identifies that the issue is linked to “US Billing Infra Service” and provides the response 302 to the task dispatcher LLM 200 that generates a corresponding natural language response 410 explaining the response 302.

Thereafter, the task dispatcher LLM 200 determines that the response 302 does not fully resolve the query 102 and generates another prompt 204 based on the query 102 and the response 302 that is routed to an LLM-based agent specialized in monitoring with the alias of “Sarah.” The task dispatcher LLM 200 generates a natural language response 410 explaining this to the user 10. The LLM-based agent specialized in monitoring processes the other prompt 204 to further identify that the issue is related to the DB2 database and provides the response 302 to the task dispatcher LLM 200 with these findings. The task dispatcher LLM 200 generates another natural language response 410 based on the response 302 and determines that the response 302 still does not sufficiently address the query 102.

To that end, the task dispatcher LLM 200 determines another task 202, another prompt 204 based on the task 202, and routes the prompt 204 to an LLM-based agent 300 specialized in DB2 databases with the alias of “John.” The task dispatcher LLM 200 generates a natural language response 410 explaining this routing to the user 10. The LLM-based agent 300 specialized in DB2 databases processes the prompt 204 and locates the issue to “KB102” and activates a workflow to resolve the issue. The LLM-based agent 300 provides the response 302 to the task dispatcher LLM 200 which generates the natural language response 410 explaining the response 302 to the user 10. Finally, the task dispatcher LLM 200 determines that this response 302 addresses the query 102 entirely and generates another natural language response 410 conveying this information to the user 10.

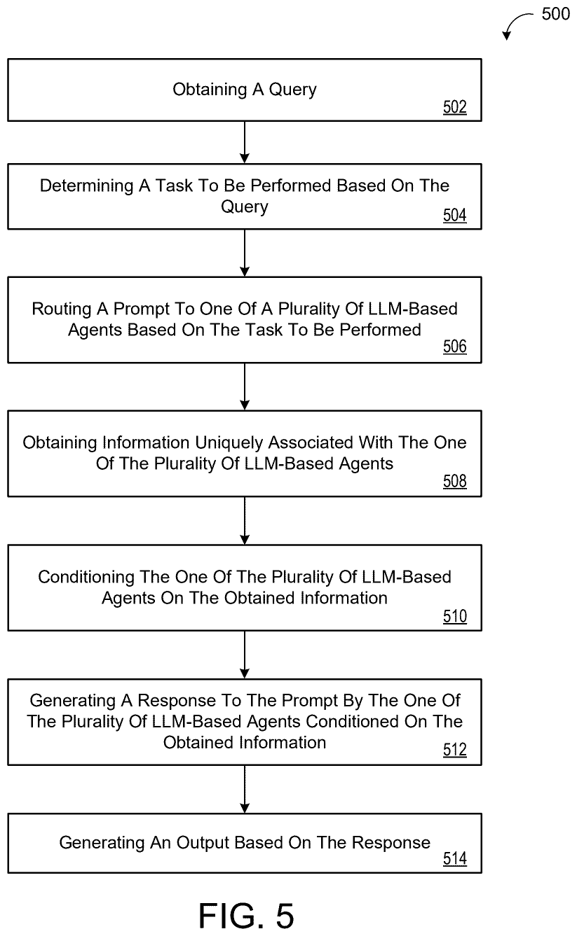

FIG. 5 is a flowchart of an exemplary arrangement of operations for a computer-implemented method 500 of processing queries using a virtual agent with a plurality of LLM-based agents. At operation 502, the method 500 includes obtaining a query 102. At operation 504, the method 500 includes determining, by a task dispatcher LLM, a task to be performed based on the query. At operation 506, the method 500 includes routing, by the task dispatcher LLM, a prompt to one of a plurality of LLM-based agents based on the task to be performed. By routing the prompt to the one of the plurality of LLM-based agents 300 specialized to perform the task 202, the virtual agent 120 ensures that a quality response 302 is output while minimizing resource consumption. At operation 508, the method 500 includes obtaining, by the one of the plurality of LLM-based agents, information uniquely associated with the one of the plurality of LLM-based agents. At operation 510, the method 500 includes conditioning the one of the plurality of LLM-based agents on the obtained information. Conditioning each LLM-based agent 300 guides each LLM-based agent 300 to perform a particular type of task 202. Moreover, the information 162 may be obtained using RAG which allows the LLM-based agent 300 to be informed of the latest data in the database 160. At operation 512, the method 500 includes generating a response to the prompt by the one of the plurality of LLM-based agents conditioned on the obtained information. At operation 514, the method 500 includes generating, by the task dispatcher, an output based on the response.

In contrast to the plurality of LLM-based agents 300 used by the virtual agent 120, traditional agent frameworks frequently employ monolithic architectures that use a single agent to perform tasks. Such monolithic architecture may result in inefficiencies, a higher likelihood of hallucinations, and limited reusability. These frameworks often lack the adaptability needed to integrate smoothly with existing tools and systems, posing challenges in utilizing previous investments in automation and workflows. Furthermore, the absence of a structured methodology for agent collaboration and task execution can lead to suboptimal performance and user experience. The multi-agent framework of the virtual agent 120 offers a solution to these challenges through a modular design that focuses on the creation and orchestration of multiple smaller agents, each assigned specific roles and capabilities. This modular approach minimizes hallucinations and enhances task resolution accuracy by ensuring that agents concentrate on well-defined tasks.

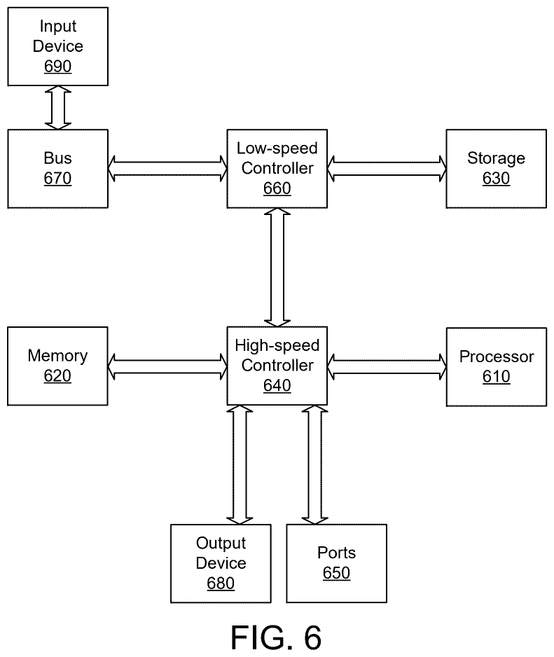

FIG. 6 is a schematic view of an example computing device 600 that may be used to implement the systems and methods described in this document. The computing device 600 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 600 includes a processor 610, memory 620, a storage device 630, a high-speed interface/controller 640 connecting to the memory 620 and high-speed expansion ports 650, and a low-speed interface/controller 660 connecting to a low-speed bus 670 and a storage device 630. Each of the components 610, 620, 630, 640, 650, and 660, are interconnected using various busses, and may be mounted on a common motherboard or in other manners as appropriate. The processor 610 can execute instructions for performing operations within the computing device 600, including instructions stored in the memory 620 or on the storage device 630 to display graphical information for a graphical user interface (GUI) on an external input/output device, such as display 680 coupled to high-speed interface 640. In other implementations, multiple processors and/or multiple buses may be used, as appropriate, along with multiple memories and types of memory. Also, multiple computing devices 600 may be connected, with each device providing portions of the necessary operations (e.g., as a server cluster, a group of blade servers, or a multi-processor system).

The memory 620 stores information within the computing device 600. The memory 620 may be a non-transitory computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 630 is capable of providing mass storage for the computing device 600. In some implementations, the storage device 630 is a non-transitory computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 620, the storage device 630, or memory on processor 610.

The high-speed controller 640 manages bandwidth-intensive operations for the computing device 600, while the low-speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port or input device 690. The low-speed expansion port 690, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining a query;
determining, by a task dispatcher LLM, a task to be performed based on the query;
routing, by the task dispatcher LLM, a prompt to one of a plurality of LLM-based agents based on the task to be performed;
obtaining, by the one of the plurality of LLM-based agents, information uniquely associated with the one of the plurality of LLM-based agents;
conditioning the one of the plurality of LLM-based agents on the obtained information;
generating, by the one of the plurality of LLM-based agents conditioned on the obtained information, a response to the prompt; and
generating, by the task dispatcher LLM, an output based on the response.

2. The method of claim 1, wherein the task dispatcher LLM determines the task to be performed using chain of thought (CoT) reasoning.

3. The method of claim 1, wherein the task to be performed is one of a sequence of tasks to be performed for the query.

4. The method of claim 1, wherein the one of the plurality of LLM-based agents obtains the information uniquely associated with the one of the plurality of LLM-based agents using retrieval augmented generation (RAG).

5. The method of claim 1, wherein the information uniquely associated with the one of the plurality of LLM-based agents comprises one or more tools associated with the one of the plurality of LLM-based agents.

6. The method of claim 1, wherein the information uniquely associated with the one of the plurality of LLM-based agents comprises one or more capabilities associated with the one of the plurality of LLM-based agents.

7. The method of claim 1, wherein the information uniquely associated with the one of the plurality of LLM-based agents comprises one or more actions associated with the one of the plurality of LLM-based agents.

8. The method of claim 1, wherein the information uniquely associated with the one of the plurality of LLM-based agents comprises a knowledge base associated with the one of the plurality of LLM-based agents.

9. The method of claim 1, further comprising:
determining, by the task dispatcher LLM, that the output resolves the query; and
providing the output as a final answer to the query.

10. The method of claim 1, further comprising:
determining, by the task dispatcher LLM, that the output does not resolve the query;
determining, by the task dispatcher LLM, a second task to be performed based on the query and the output; and
routing, by the task dispatcher LLM, a second prompt to a second one of the plurality of LLM-based agents based on the second task to be performed.

11. The method of claim 10, further comprising:
obtaining, by the second one of the plurality of LLM-based agents, second information uniquely associated with the second one of the plurality of LLM-based agents;
conditioning the second one of the plurality of LLM-based agents on the obtained second information;
generating, by the second one of the plurality of LLM-based agents conditioned on the obtained second information, a second response to the second prompt; and
generating, by the task dispatcher LLM, a second output based on the second response to the second prompt.

12. The method of claim 11, further comprising:
determining, by the task dispatcher LLM, that the second output resolves the query; and
providing the second output as a final answer to the query.

13. The method of claim 1, wherein each LLM-based agent of the plurality of LLM-based agents is conditioned to perform a respective type of task.

14. The method of claim 13, wherein the task dispatcher LLM is prompted on the respective type of task that each LLM-based agent of the plurality of LLM-based agents is conditioned to perform.

15. The method of claim 1, wherein the prompt comprises a natural language description of the task to be performed.

16. The method of claim 1, further comprising generating, by a virtual agent, a natural language response based on the output.

17. The method of claim 16, further comprising displaying the natural language response on a graphical user interface of a user device.

18. The method of claim 1, wherein conditioning the one of the plurality of LLM-based agents on the obtained information comprises at least one of:
prompting the one of the plurality of LLM-based agents using the obtained information;
training the one of the plurality of LLM-based agents on the obtained information; or
fine-tuning the one of the plurality of LLM-based agents on the obtained information.

19. A system comprising:
data processing hardware; and
memory hardware in communication with the data processing hardware, the memory hardware storing instructions that when executed on the data processing hardware cause the data processing hardware to perform operations comprising:
obtaining a query;
determining, by a task dispatcher LLM, a task to be performed based on the query;
routing, by the task dispatcher LLM, a prompt to one of a plurality of LLM-based agents based on the task to be performed;
obtaining, by the one of the plurality of LLM-based agents, information uniquely associated with the one of the plurality of LLM-based agents;
conditioning the one of the plurality of LLM-based agents on the obtained information;
generating, by the one of the plurality of LLM-based agents conditioned on the obtained information, a response to the prompt; and
generating, by the task dispatcher LLM, an output based on the response.

20. A computer-readable medium having instructions that, when executed by data processing hardware, causes the data processing hardware to perform operations comprising:
obtaining a query;
determining, by a task dispatcher LLM, a task to be performed based on the query;
routing, by the task dispatcher LLM, a prompt to one of a plurality of LLM-based agents based on the task to be performed;
obtaining, by the one of the plurality of LLM-based agents, information uniquely associated with the one of the plurality of LLM-based agents;
conditioning the one of the plurality of LLM-based agents on the obtained information;
generating, by the one of the plurality of LLM-based agents conditioned on the obtained information, a response to the prompt; and
generating, by the task dispatcher LLM, an output based on the response.
